(19) United States
(12) Patent Application Publication
(10) Pub. No.: US 2015/0159415 A1
(43) Pub. Date: Jun. 11, 2015

(54) PULL-OUT GUIDE

(71) Applicant: PAUL HETTICH GMBH & CO. KG, Kirchlengern (DE)

(72) Inventors: Daniel Rehage, Bielefeld (DE); Daniel Reidt, Herford (DE); Friedrich Meyer, Bohmte (DE)

(21) Appl. No.: 14/412,768

(22) PCT Filed: Jul. 2, 2013
(86) PCT No.: PCT/EP2013/063907

§ 371 Date: Jan. 5, 2015

(30) Foreign Application Priority Data
Oct. 12, 2012 (DE) 10 2012 109 753.4
Dec. 7, 2012 (DE) 10 2012 106 287.0
Mar. 22, 2013 (DE) 10 2013 102 949.3

(51) Int. Cl. E05D 15/06

(52) U.S. Cl. CPC E05D 15/0621

(57) ABSTRACT

The invention relates to a pull-out guide comprising a fixable guide rail; a running rail which is movably mounted via rolling bodies, wherein a central rail is optionally arranged between the guide rail and the running rail; and at least one latching device with a flexible spring element for removably fixing the running rail, the guide rail, and/or the optional central rail in a latching position. The spring element engages between two rolling bodies in the latching position in order to prevent the running rail, the guide rail, and/or the optional central rail from moving. In this manner, the spring element can be moved by means of the rolling body such that the contact surfaces lie in a lubricated region, thereby extending the service life.

This application is a U.S. nationalization under 35 U.S.C. §371 of International Application No. PCT/EP2013/063907, filed Jul. 2, 2013, which claims priority to German Application Nos. DE10 2012 106 287.0, filed Jul. 12, 2012; DE10 2012 109 753.4, filed Oct. 12, 2012, and DE10 2013 102 949.3, filed Mar. 22, 2013. The disclosures set forth in the foregoing applications are incorporated herein by reference in their entireties.

### BACKGROUND AND SUMMARY OF THE DISCLOSURE

The present invention relates to a pull-out guide comprising a fixable guide rail, a running rail which is movably mounted via rolling bodies, an optional middle rail between the guide rail and running rail, and at least one latching device with a flexible spring element for releasably fixing the running rail, the guide rail and/or the optional middle rail in a latching position.

DE 80 30 718 discloses a baking oven in which a baking carriage is movably mounted via rollers. The rollers can be secured on latching springs with a latching roller in a closed position of the baking carriage. Although the arrangement of a latching roller on a spring element can reduce the frictional forces and thus wear and tear, mounting is comparatively complex. Moreover, the rollers are only lubricated in their bearing region, so that wearing phenomena can occur on the contact areas of the rollers during repetitive operation.

WO 2010/060724 discloses a pull-out guide in which a spring element is arranged within the pull-out guide and cooperates with a profiling or recess on a rail in order to latch the running rail in a predetermined position. The spring element is arranged at a distance from a running surface of a rolling body, so that a compact configuration can be achieved, but the problem still exists that the spring element and the profiling or recess are not lubricated, so that wearing phenomena can occur in the case of permanent operation on the sliding surfaces, especially when the latching forces are chosen to be slightly greater.

It is an object of the present disclosure to provide a pull-out guide which allows secure latching of the running rail in a latching position and in which the wear and tear of the latching device is reduced.

In accordance with the disclosure, the flexible spring element engages in the latching position between two rolling bodies in order to secure the running rail, the guide rail and/or the optional middle rail against displacement. A part of the spring element thus comes into contact with a rolling body which is lubricated on the surface. As a result, the contact surface of the spring element is also lubricated with a thin layer of lubricant, which considerably reduces the wear and tear on the surface of the contact area and reduces the frictional forces. Wear and tear of the spring element can thus be prevented substantially even the case of repetitive operation over several years.

The spring element is preferably fixed to the running rail or the guide rail, especially to an exterior side of the respective rail. As a result, mounting of the spring element can be performed in a simple way, wherein the fixing of the spring element preferably occurs by welding, but also by other fastening means such as rivets or gluing. The fixing of the spring element can occur in a frictionally engaged, interlocking or materially bonded manner.

According to an embodiment of the invention, the spring element penetrates a recess in the running rail or the guide rail. The recess can be arranged in the region of a running track of a rolling body, so that a tip of the spring element protrudes into the region of the track and can thus come into contact with a rolling body. The spring element can have a substantially V-shaped tip, which can be moved from either side by a movement of the rolling body. The angle of inclination of the V-shaped tip can be chosen depending on the latching forces that are required for securing the running rail in the latched position.

The latched position of the running rail, the guide rail and/or the optional middle rail can be defined on the one side by the spring element and on the other side by a limit stop, wherein the limit stop can be formed on the running rail by an embossed portion in order to prevent a rolling body, a rolling body cage or the middle rail from further movement. The latched position can retain the running rail with a certain amount of play, wherein the play preferably lies in a range of between 1 to 10 mm, especially 3 to 6 mm.

The running rail and/or the guide rail are arranged in a substantially U-shaped manner in their cross-section for a compact configuration of the pull-out guide, wherein at least one leg is arranged in an inwardly curved manner at the end side for forming a track for a rolling body. Three rolling bodies can preferably be provided per running rail or guide rail in one plane perpendicularly to the longitudinal direction of the running rail or the guide rail in order to ensure a stable longitudinal guidance. The rolling bodies can be retained on a rolling body cage at a distance from each other.

The pull-out guide optionally comprises a middle rail between the running rail and the guide rail, wherein a second latching device is fixed to the guide rail in order to secure the middle rail in a latched position against displacement, because the running rail can also be latched in a pull-out position only in this way. The number of latching positions can be chosen substantially at will, wherein preferably latching occurs in a pull-out position and optionally also in a retracted position. Two, four or more than four latching devices can thus be provided on the pull-out guide. The pull-out guide is preferably arranged as a full-extension pull-out guide or over-extension pull-out guide, so that a sliding element can also be moved in front of a furniture body or a domestic appliance.

For the purpose of a stable arrangement of the spring element, it is preferably produced from steel sheet, which is also arranged to be temperature-resistant. The spring element can comprise a web adjacent to the tip, which web is arranged in a curved manner for forming a track for the rolling body. Especially when the web and the tip are arranged in the region of a track for a rolling body, the spring element can form a certain guidance of the rolling body by a curvature perpendicular to the longitudinal direction of the rail in order to not deflect said rolling body in the region of the recess from its trajectory.

In accordance with a further embodiment, the latching device comprises several flexible spring elements, which respectively comprise a tip and can be latched on a rolling body. The spring elements can thus be latched on two or three or more rolling bodies simultaneously. This leads to the advantage that the latching forces can be arranged to be higher and furthermore the loading of the spring elements occurs in opposite directions, so that torsional loading of the running rail does not occur.

The pull-out guide in accordance with the disclosure may be used in a pull-out system of a baking oven. The use in other domestic appliances, vehicles and pieces of furniture is possible.

### BRIEF DESCRIPTION OF THE DRAWINGS

FIG. 1 shows a perspective view of an illustrative pull-out guide in accordance with the disclosure in a retracted position;

FIG. 2 shows a perspective view of the pull-out guide of FIG. 1 in a pull-out position;

FIGS. 3A to 3C show several schematic views of an illustrative embodiment latching device in different positions;

FIG. 4 shows a cross-sectional view of the pull-out guide of FIG. 1 in the region of the latching device;

FIG. 5 shows a perspective exploded view of another illustrative latching device;

FIG. 6 shows a sectional view of a pull-out guide with the latching device according to FIG. 5;

FIGS. 7A and 7B show two perspective views of another illustrative pull-out guide;

FIG. 8 shows a rear view of the pull-out guide of FIG. 7;

FIGS. 9A and 9B show two perspective views of the latching mechanism of the pull-out guide of FIG. 7;

FIG. 10 shows a perspective detailed view of the pull-out guide of FIG. 7;

FIGS. 11A and 11B show two perspective views of the pull-out guide of FIG. 7 in the extended position;

FIG. 12 shows a sectional rear view of the pull-out guide of FIG. 7;

FIGS. 13 and 14 show several views of a further illustrative pull-out guide in accordance with the invention, and

FIGS. 15A to 15E show several views of a further illustrative latching element for a pull-out guide.

### DETAILED DESCRIPTION

A pull-out guide 1 comprises a guide rail 2 which can be fixed to a furniture body or a domestic appliance and on which a middle rail 3 is movably mounted. A running rail 4 is movably mounted on the middle rail 3. A sliding element such as a carrier for cooked products can be placed on the running rail 4. A plurality of rolling bodies 5 in the form of balls is provided between the guide rail 2 and the middle rail 3 as well as the running rail 4 and the middle rail 3. In other embodiments, rolling bodies in the form of other shapes, for example, cylindrical rollers or other shapes can be used.

In order to latch the running rail 4 in a predetermined position, a latching device 6 is provided which comprises a flexible spring element 7, preferably made of a steel sheet. The spring element 7 is fixed to fastening points 8 on an exterior side of the running rail 4, e.g. by welding, although other fastening means can also be used. A latching device 6 is fixed to the guide rail 2, which guide rail is also arranged as the latching device 6 on the running rail 4. The middle rail 3 can be latched in a latching position via the latching device 6 on the guide rail 2.

The spring element 7 comprises a substantially V-shaped tip 9, which penetrates a rectangular recess 10 in the guide rail 2 or the running rail 4. The recess 10 is arranged in a middle region of the guide rail 2 or the running rail 4, wherein the recess 10 can also be arranged to be open towards one side.

The tip 9 penetrates the recess 10 which is arranged in the region of a track 12 for the rolling bodies. The guide rail 2 and the running rail 4 have a substantially U-shaped cross-section, wherein one leg of the U is arranged in an inwardly curved manner, so that three tracks 12 for the spherical rolling bodies 5 are formed both on the guide rail 2 and also on the running rail 4. The legs of the “U” may have different lengths. The middle rail 3 comprises two cross-shaped sections which are connected to each other via a middle web. Three tracks 11 for the rolling bodies 5 are formed on each of the cross-shaped sections.

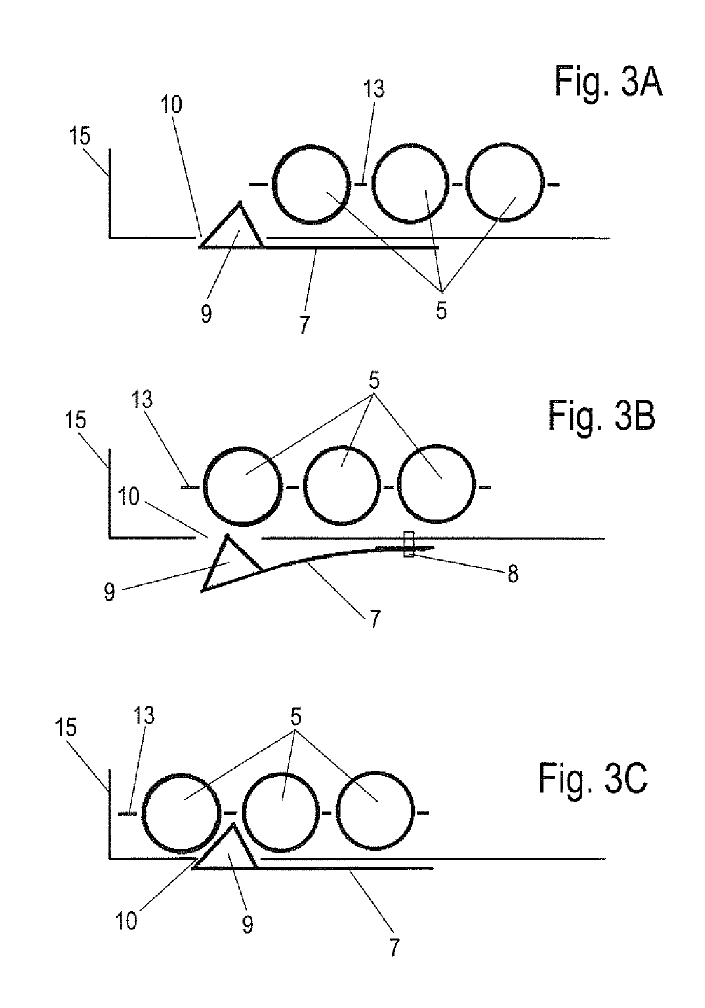

The latching device is schematically shown in FIGS. 3A to 3C. Several spherical rolling bodies 5 are retained on a rolling body cage 13, which rolling bodies approach the tip 9 of the spring element 7 in FIG. 3A. The front rolling body 5 now meets the tip 9 of the spring element 7, so that the tip 9 is bent outwardly, wherein the spring element 7 is fixed by the fastening point 8 to the running rail 4 or the guide rail 2. The position shown in FIG. 3C is subsequently reached, in which the front rolling body 5 has passed the tip 9, which is now disposed between the adjacent rolling body 5 and the front rolling body 5 at the edge. The front rolling body 5 is now retained between the schematically shown limit stop 15 and the tip 9 of the spring element 7. This latching position of the rolling body 5 can be arranged with play, e.g. in a range of between 3 mm and 8 mm. The distance of the rolling bodies 5 can be arranged slightly farther apart than is schematically shown in FIGS. 3A to 3C.

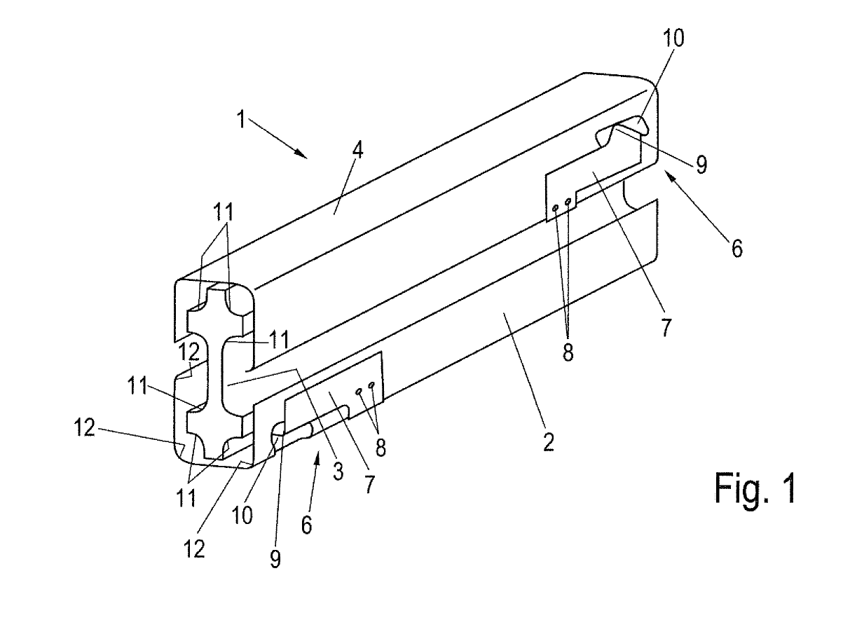

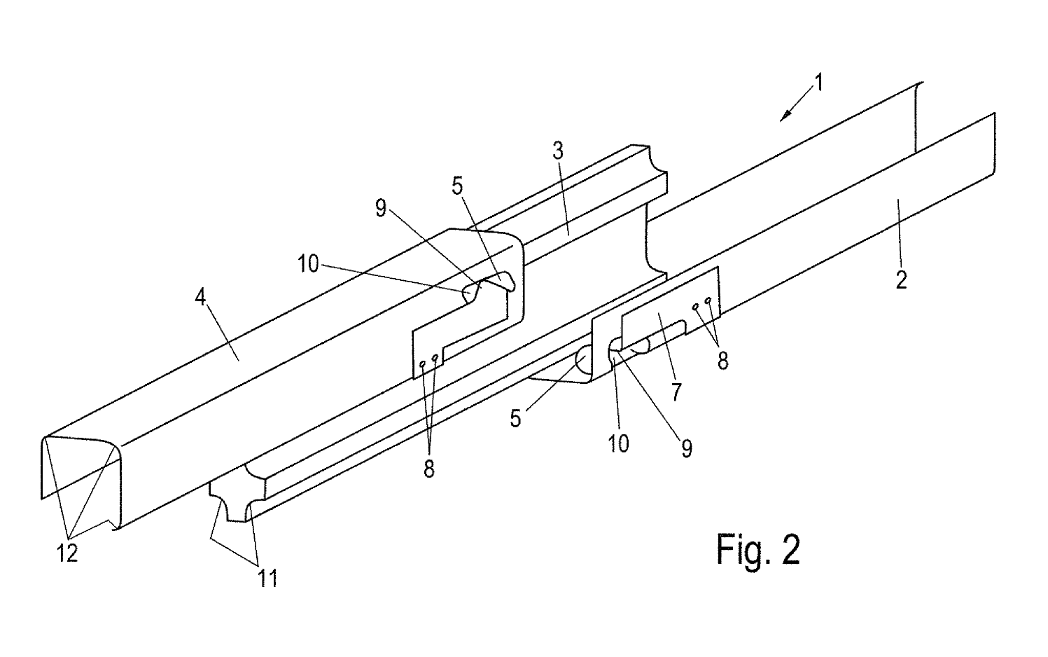

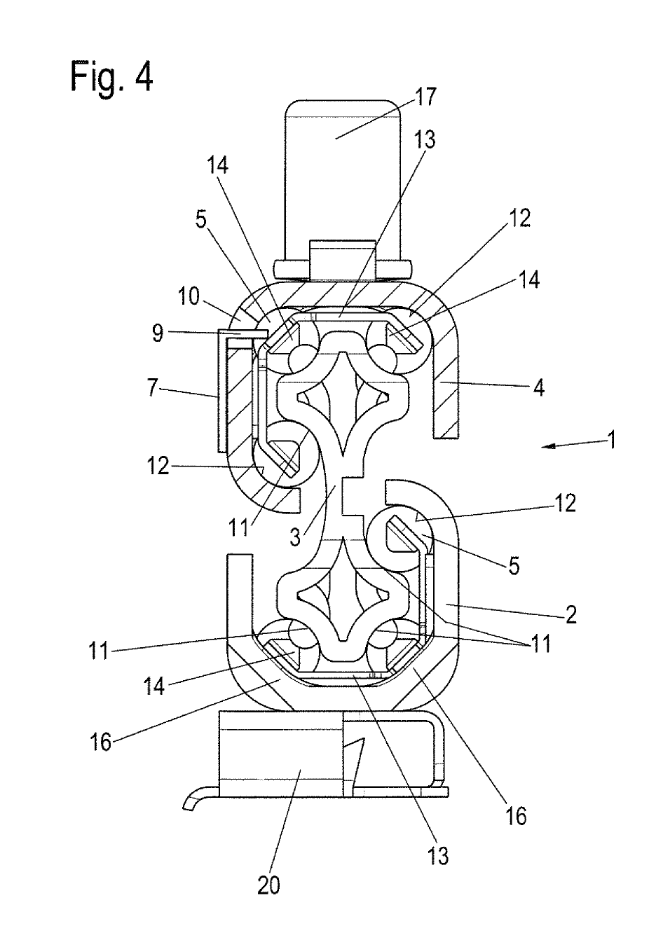

FIG. 4 shows a sectional view of the pull-out guide of FIG. 1 in the region of the latching device 6 on the running rail 4. A clamp 20 is fixed to the guide rail 2 on its bottom side, by means of which the guide rail 2 can be fixed to a further component, e.g. a side grating in a baking oven. Three tracks 11 with rolling bodies 5 are respectively provided on the lower portion of the middle rail 3 in order to displaceably mount the middle rail 3 relative to the guide rail 2. Three more tracks 11 with rolling bodies 5 are respectively provided on the upper portion of the middle rail 3 in order to displaceably mount the middle rail 3 relative to the running rail 4. Three rolling bodies 5 in a plane perpendicularly to the longitudinal direction of the middle rail form a set of rolling bodies, wherein several such sets of rolling bodies 5 are provided in the longitudinal direction. The rolling bodies 5 are held in a rolling body cage 13, which comprises a pocket for each rolling body 5. A bent tab 14 is provided in order to guide the rolling body 5 in the pocket and to keep a substantially constant distance of the rolling bodies 5 from each other.

The spring element 7 is fixed to the exterior of one side of the running rail 4 and the tip 9 extends through the recess 10 up to the region in which the rolling body 5 is displaceably mounted. The tip 9 can protrude into the region of the rolling body 5 in a range of between 0.5 mm to 5 mm, especially 1 to 2 mm. The rolling body cage 13 does not obstruct the tip 9 because the rolling body cage 13 is loosely arranged between the running rail and the middle rail 3 and can also be displaced by the tip 9 if necessary. Once the rolling body 5 passes the tip 9, the tip 9 pressed to the outside and partly from the recess 10 in order to subsequently latch behind the first rolling body 5 so that the running rail 4 is held in the latching position.

The latched position is defined on the one hand by the tip 9 of the spring element 7, and on the other hand by limit stops in form of embossed portions 16 that are arranged on the running rail 4 and the guide rail 2, which limit stops prevent the rolling bodies 5 from moving beyond the embossed portions 16. The running rail 4 also comprises such embossed portions 16, which are shown in FIG. 4 only for the guide rail 2.

An upwardly protruding plug 17 is further fixed to the running rail 4, which plug is used for fixing a further component, e.g. a carrier for cooked products.

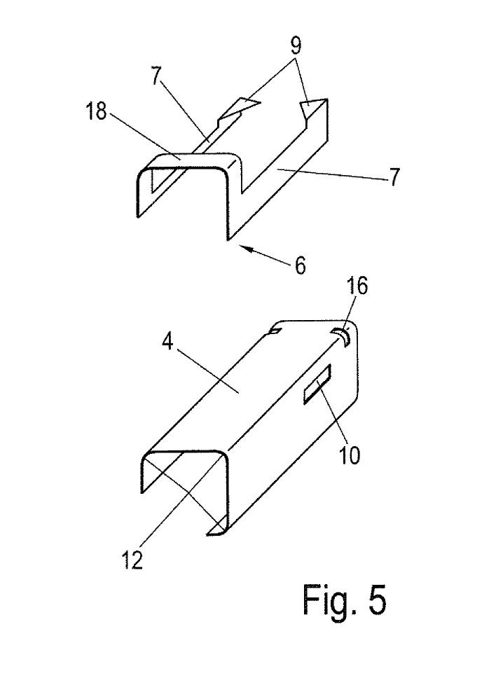

FIG. 4 shows a single spring element 7 with one tip 9 per running rail 4 or guide rail 2. It is also possible to provide a latching device 6 which simultaneously comes into engagement with two or more rolling bodies 5. FIG. 5 shows the rear section of the running rail 4, in which a latching device is provided in which two spring elements 7 are provided which respectively comprise a tip 9 which penetrate a recess 10 on opposite sides of the running rail 4. The spring elements 7 are connected to each other via a bracket 18 and can be clipped onto the running rail 4 for example. Each tip 9 of a spring element 7 comes into engagement during a sliding movement with a rolling body 5 arranged at the end side in order to latch the same between an embossed portion 16 and the tip 9. The bending forces acting on the spring element 7 cancel each other out because the spring elements 7 are bent in opposite directions. As a result, no bending forces or torsional forces act on the running rail 4 during latching.

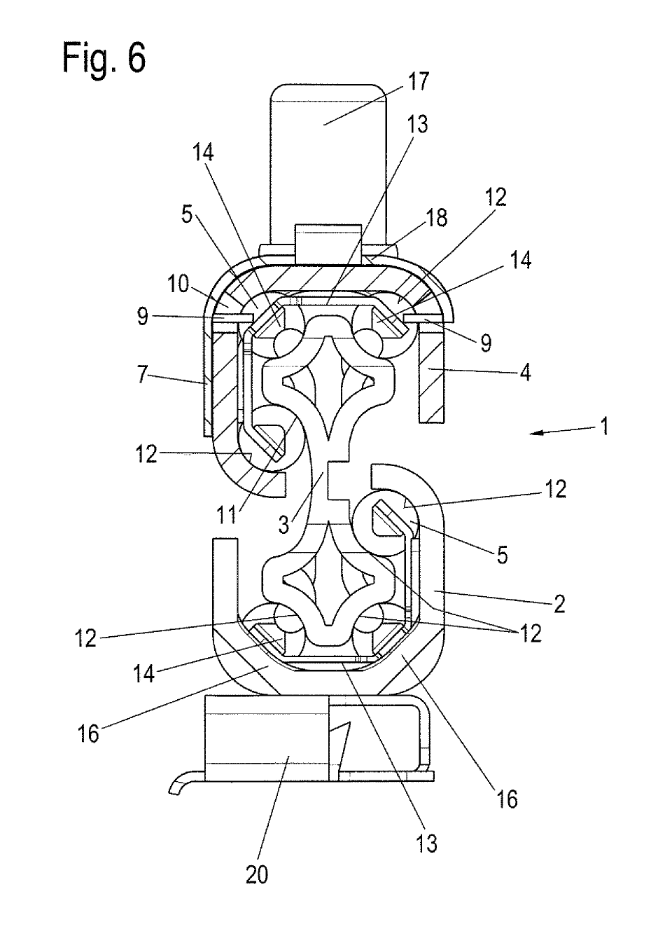

FIG. 6 shows the latching device shown in FIG. 5 in the mounted position. The bracket 18 engages around the upper side of the running rail 4 and on opposite sides of the running rail 4 a tip 9 protrudes through a respective recess 10 into the region of the rolling bodies 5. When the rolling bodies 5 travel over the tips 9, the tips are pressed outwardly (to the right and the left), wherein the latching forces acting on the latching device cancel each other out.

FIG. 5 shows a latching device with two spring elements 7, which simultaneously latch a rolling body 5. It is also possible to provide three spring elements 7 which are latched onto three rolling bodies 5 of a set of rolling bodies 5.

The latching device for the running rail 4 shown in FIGS. 5 and 6 can also be provided on the guide rail 2 for latching the middle rail 3.

In the illustrated embodiments, the pull-out guide 1 comprises a guide rail 2, a middle rail 3 and a running rail 4. It is also possible to provide a pull-out guide with only two rails or more than three rails with the latching device in accordance with the disclosure.

The tips 9 on the spring element 7 are shown as thin-walled webs in the illustrated embodiments. It is also possible to arrange the tips 9 in the manner of strips and to provide them with a curvature for example which substantially corresponds to the curvature of the tracks 11 and 12. As a result, the rolling bodies 5 can be guided in the region of the tips 9 to a certain extent. Furthermore, the force is distributed to a larger area during latching of the rolling bodies 5, which further reduces wear and tear. Furthermore, the tip 9 can also be rounded off or arranged in an arc-shaped manner at the front end in order to obtain smoother movements of the spring element 7 during latching.

The latching device in accordance with the invention also allows compensating tolerances during the assembly of the guide rail 2, the middle rail 3 and the running rail 4. Furthermore, the latching effect remains substantially constant over the service life, because the contact surface on the tip 9 is situated in a lubricated region because the rolling bodies 5 on the tracks 11 and 12 are also coated with lubricant.

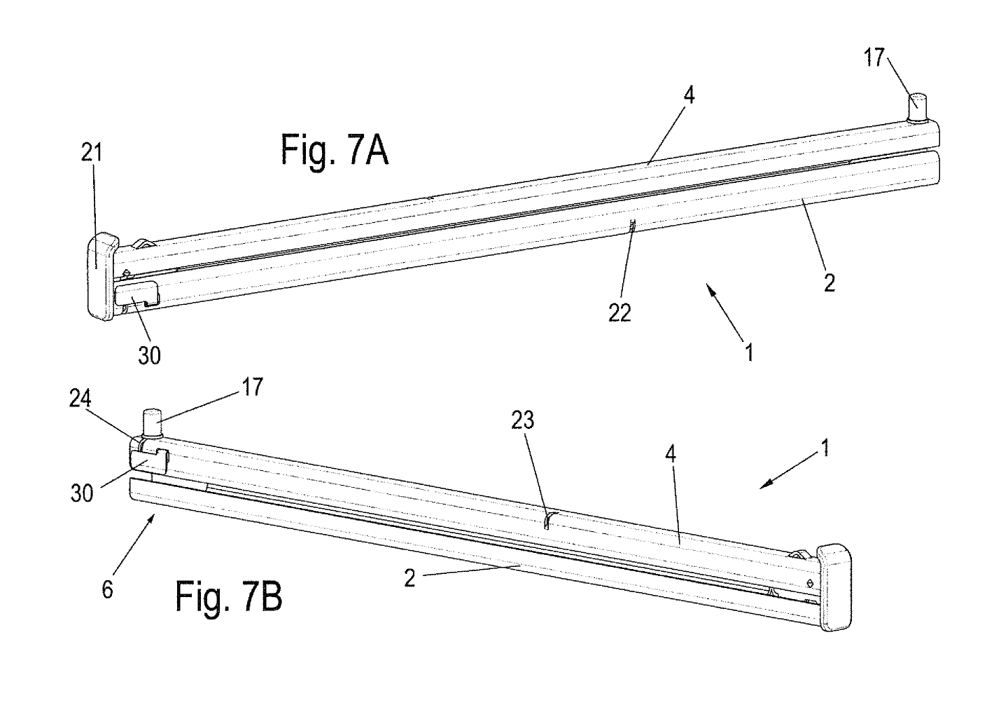

FIGS. 7 to 12 show a further embodiment of a pull-out guide 1, wherein like components are designated with like reference numerals. The pull-out guide 1 comprises a guide rail 2 which can be fixed to a furniture body and on which a middle rail 3 is displaceably mounted, said middle rail 3 being fixable via a first latching device 30, and further a second latching device 30 by means of which a running rail 4 can be fixed to the middle rail 3.

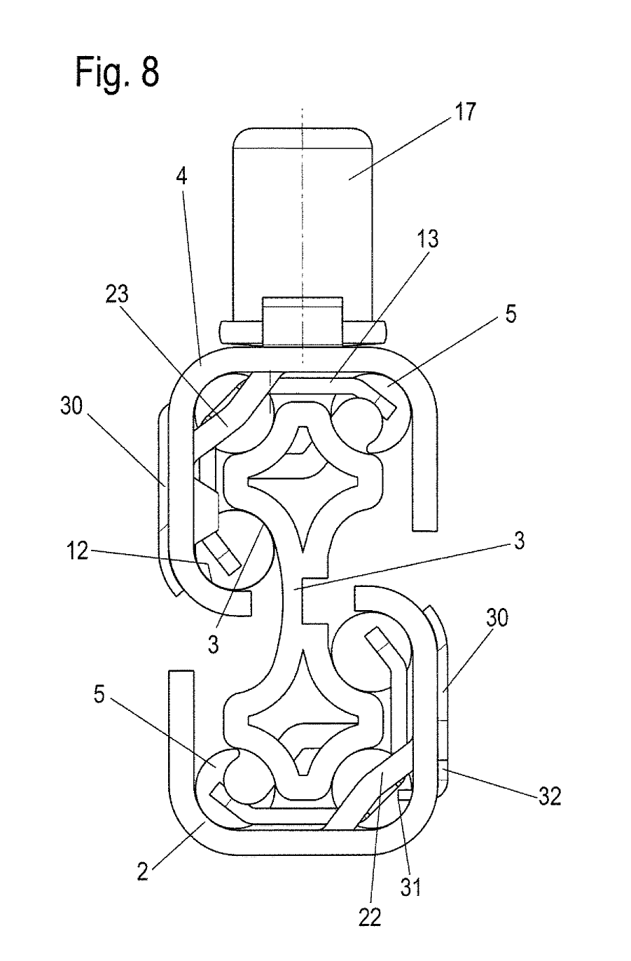

As is also shown especially in FIG. 8, the guide rail 2 comprises an inwardly facing, web-like profiling 22 which is used as a limit stop for a rolling body cage 13 with rolling bodies 5 between the guide rail 2 and the middle rail 3. A web-like profiling 23 is similarly also arranged as a limit stop on the running rail 4. A further profiling 24 is provided on an end section of the running rail 4 adjacent to the plug 17, so that a rolling body cage 13 with rolling bodies 5 is movable between the two profilings 23 and 24.

The latching devices 30 are made of a flexible sheet metal, wherein a bent-off projection 31 is provided which penetrates a recess 10 and engages into the trajectory of a rolling body 5. When the rolling body 5 is displaced along the tracks 11 and 12, the projection 31 of the latching device 30 can be moved to the outside, wherein the latching device 30 surrounds a flexible section 32. The deflection of the projection 31 of the latching device 30 can lie in a range of between 0.1 mm and 6 mm, especially 1 mm to 3 mm. The projection 31 can be arranged in a tapering V-shaped manner, so that the rolling body 5 is respectively guided via a guide bevel on the projection 31.

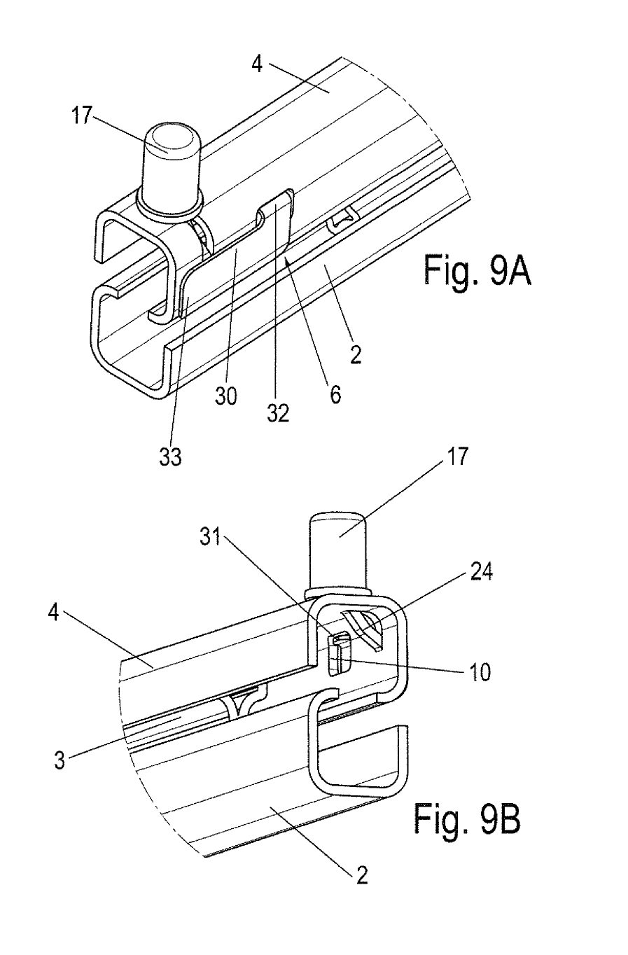

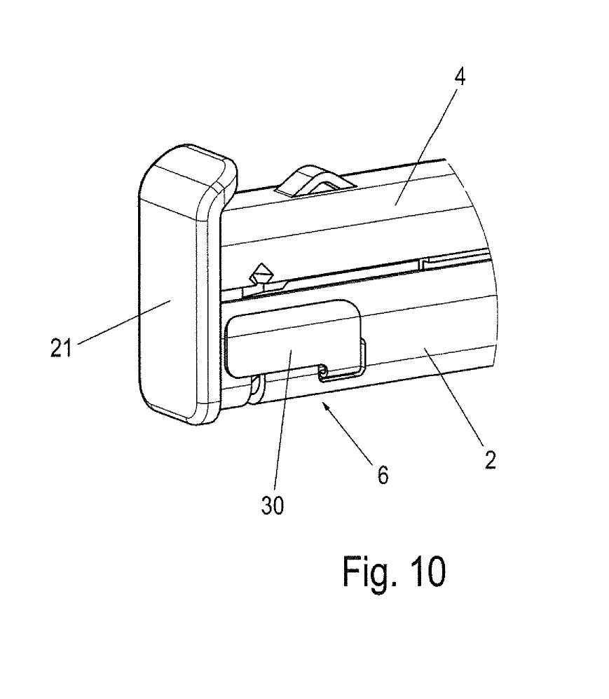

FIGS. 9A and 9B show the latching device 30 on the running rail 4, in which the projection 31 penetrates the recess 10. FIG. 10 shows the latching device 30 on the guide rail 2, which has the same configuration as the latching device 30 on the running rail 4. In a fixing region 33, the latching device 30 is connected to the rail 2, 4 in a frictionally engaged, interlocking or materially bonded manner.

FIG. 10 shows a plate 21 as a front termination of the pull-out guide 1.

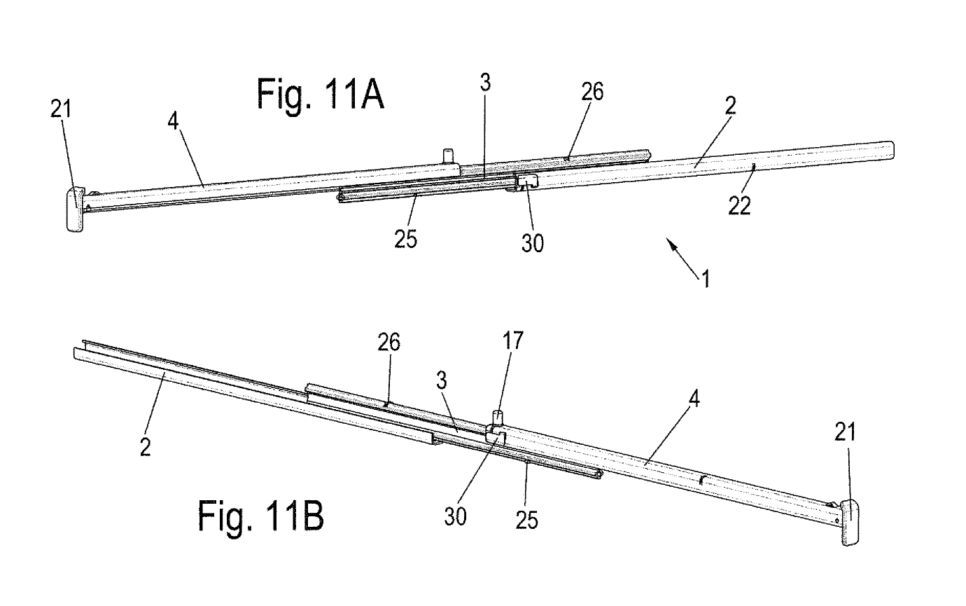

FIGS. 11A and 11B show the pull-out guide 1 in the extended position. The running rail 4 is arranged at a distance from the guide rail 2, wherein the profilings 25 and 26 on the middle rail are visible in the extended state. The profiling 25 forms a stop for the rolling body cage 13 between the guide rail 2 and the middle rail 3, whereas the profiling 26 forms a stop for the rolling body cage 13 between the middle rail 3 and the running rail 4. In the extended position, the latching devices 30 are respectively situated in the latched position, so that the running rail 4 can be pushed to the retracted position only after overcoming specific latching forces.

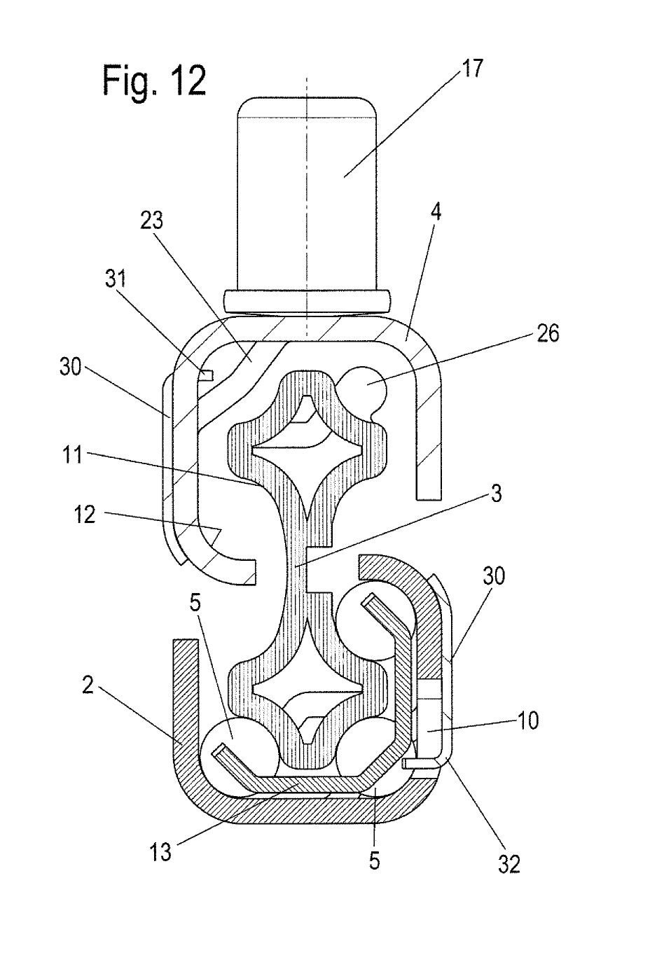

FIG. 12 shows a sectional view through the pull-out guide 1 in the latched position. The latching device 30 engages with a projection 31 into the trajectory of the rolling body 5 and is guided through the recess 10 on the guide rail 2. The profilings 26 and 23 can be seen in the region of the running rail 4, wherein no rolling body cage 13 with the rolling bodies 5 is shown in the sectional view.

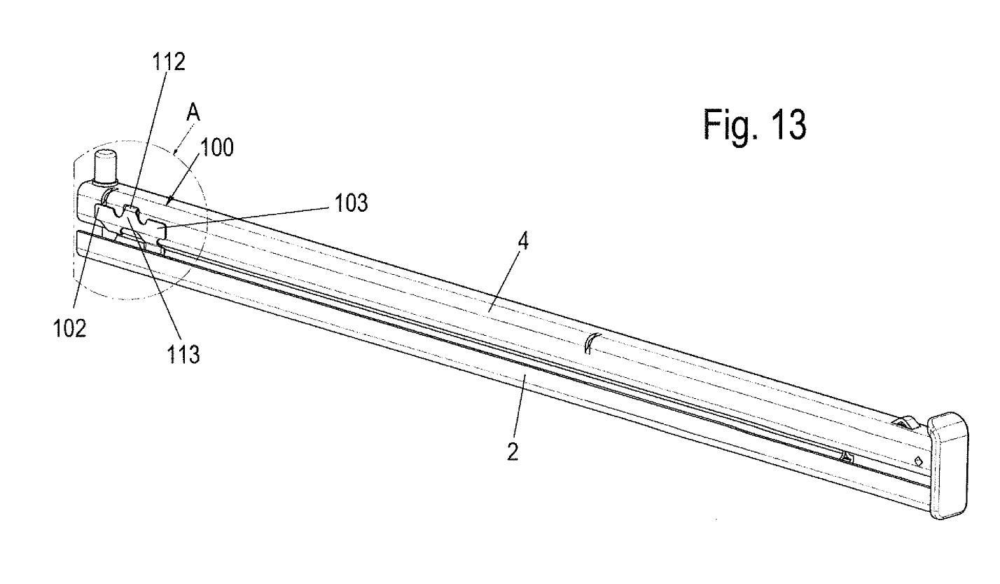

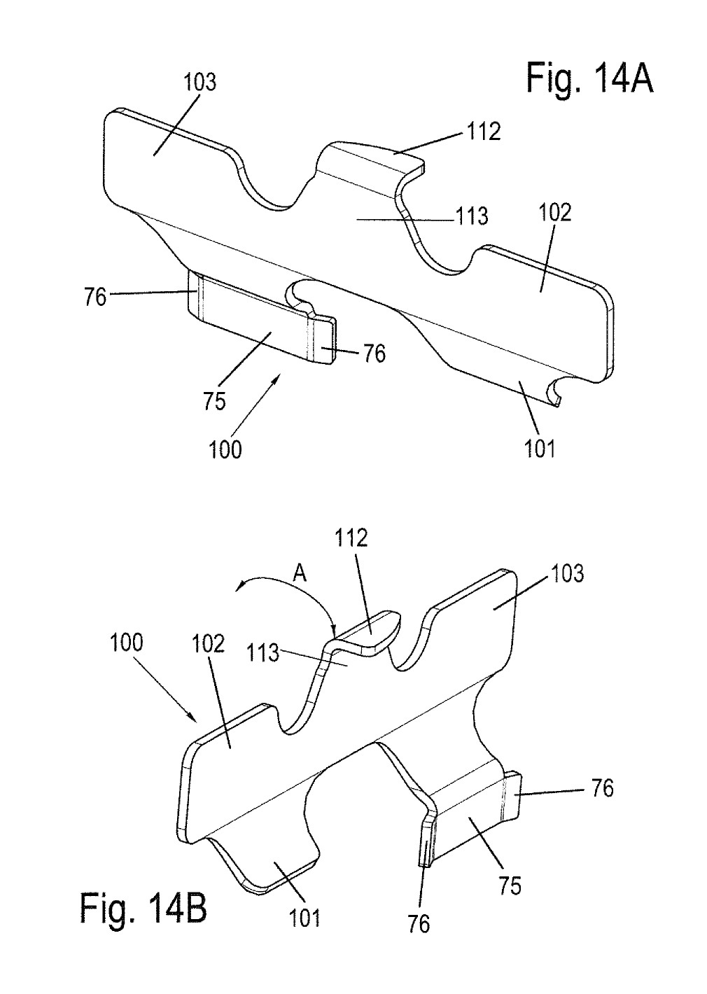

FIGS. 13 and 14 show an embodiment of a further latching mechanism 100. The latching mechanism 100 is made of a flexible sheet metal, which is fixed to fastening sections 102 and 103 on the rail 4. An angular projection 112 is formed in a middle region of the latching mechanism 100, which projection engages in an opening of the rail 4 and can be latched there behind a rolling body 5 or between two rolling bodies 5. The projection 112 comprises guide bevels on opposite sides in order to enable latching and releasing of the latched connection. A spring bar 113 is adjacent to the projection 112, which spring bar can be deflected transversely to the longitudinal direction of the rail 4. A deflection A of the flexible spring bar is shown by an arrow and it occurs around approximately 90° to the pull-outdirection. The spring direction thus faces transversely to the rail 4. A region 101 is used for supporting the spring bar 113 and extends the same on the side facing away from the projection 112. The spring constant can thus be increased or the spring effect can be provided with a softer configuration. Furthermore, the region 101 offers advantages in respect of tooling through symmetry to the adjacent region in the production of left and right parts, wherein identical tools can be used over many process steps. Furthermore, a more precise positioning of the component can occur prior to welding, and the region 101 is thus used as a positioning aid prior to fixing to the rail 4. A plate-shaped section 103 is formed on the side diametrically opposite of the region 101, which section is connected to an unlocking element 75 with guide bevel 76 on opposite sides. The region 101 is not connected to the rail 4, but rests freely thereon.

The measures on the latching mechanism 100 as described above in comparison with the embodiment as described above lead to an increase in the service life and to a reduction in the likelihood of an operating error or damage to the latching mechanism.

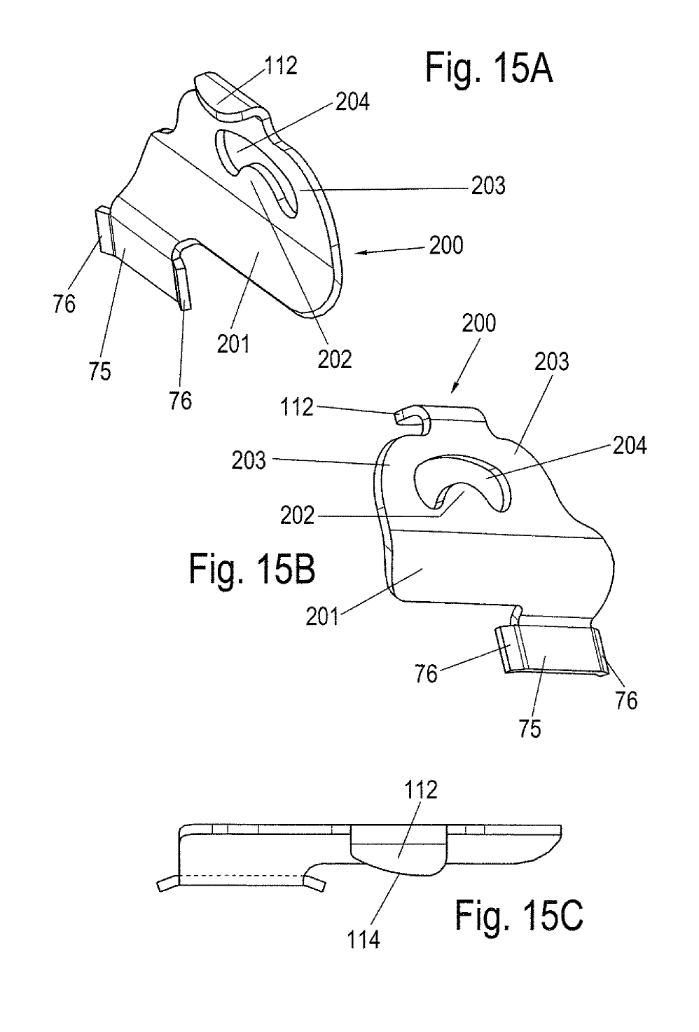

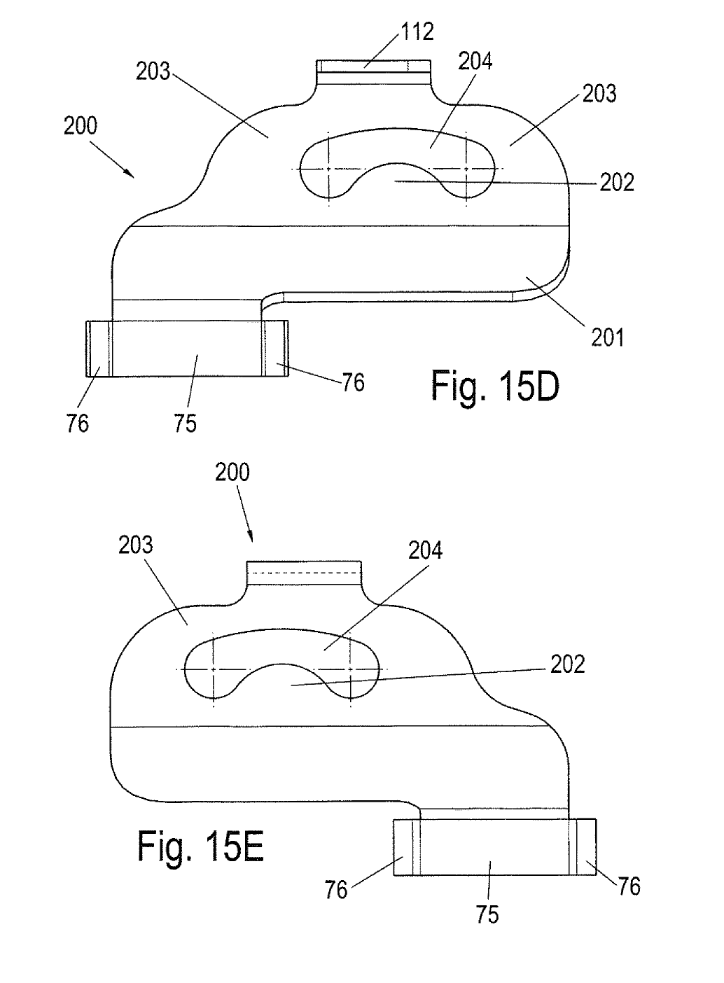

FIGS. 15A to 15E show a further embodiment of a latching mechanism 200. A region 201 comes to rest on the rail 4 and is used as a support for the guide bevels 76 and an unlocking element 75 for a locking mechanism. Fixing of the latching mechanism 200 to the rail 4 occurs on a fastening section 202, preferably by welding. The fastening section 202 is surrounded by a relief opening 204, which is arranged in an approximately kidney-shaped or semicircular fashion. The relief opening 204 was dimensioned by determining the stress distributions within the latching mechanism. One respective spring bar 203 is arranged on either side of the relief opening 204, which spring bar connects the fastening section 202 with the projection 112. The projection 112 has an arc-shaped contour 114 which is nearly kidney-shaped. A smooth progression of the latching and unlatching process is ensured by the contour 114. Tension fractures are avoided by the introduction and configuration of the relief opening 204.

The pull-out guide 1 and the respective latching mechanism can be made entirely from metallic components, preferably punched and bent sheet metals. As a result, the pull-out guide 1 can preferably be used for domestic appliances such as baking ovens, and are especially provided with high temperature resistance. Use in other areas such as furniture, refrigerators or other purposes is also possible.

1. A pull-out guide, comprising a fixable guide rail, a running rail which is movably mounted via rolling bodies, between which a middle rail is optionally arranged, and at least one latching device with a flexible spring element for releasably fixing the running rail, the guide rail and/or the optional middle rail in a latched position, wherein the spring element engages in the latched position between two rolling bodies in order to secure the running rail, the guide rail and/or the optional middle rail against displacement.

2. A pull-out guide according to claim 1, wherein the spring element is fixed to the running rail or the guide rail.

3. A pull-out guide according to claim 2, wherein the spring element is fixed to an exterior side or inner side of the running rail or the guide rail.

4. A pull-out guide according to claim 1, wherein the spring element penetrates a recess in the running rail or the guide rail.

5. A pull-out guide according to claim 4, wherein the recess is arranged in the region of a track of a rolling body.

6. A pull-out guide according to claim 1, wherein that the spring element comprises a substantially V-shaped tip or a bent-off projection (112), which spring element or tip can be latched behind a rolling body.

7. A pull-out guide according to claim 1, preceding wherein that the latched position adjacent to the spring element is defined by a limit stop (15, 24).

8. A pull-out guide according to claim 1, wherein the running rail or the guide rail is held with play in the latched position, preferably between 1 to 10 mm of play, especially 3 to 6 mm of play.

9. A pull-out guide according to claim 1, wherein the running rail and/or the guide rail have a substantially U-shaped cross-section and at least one leg is arranged in an inwardly curved manner at an end thereof for forming a track for a rolling body.

10. A pull-out guide according to claim 1, wherein the pull-out guide comprises a middle rail between the running rail and the guide rail, and a second latching device is fixed to the guide rail in order to secure the middle rail in a latched position against displacement.

11. A pull-out guide according to claim 10, wherein the pull-out guide is arranged as a full-extension pull-out guide or over-extension pull-out guide.

12. A pull-out guide according to claim 1, wherein the spring element and/or a latching mechanism is made of a steel sheet.

13. A pull-out guide according to claim 1, wherein the spring element comprises a web adjacent to the tip, which web is arranged in a curved fashion for forming a track for a rolling body.

14. A pull-out guide according to claim 1, wherein the spring element comprises several flexible webs, which respectively comprise a tip and each tip can be latched onto a rolling body.

15. A baking oven with a pull-out system for displacing at least one carrier for a cooking product, wherein the pull-out system comprises a pull-out guide according to claim 1.
